(19) United States
(12) Patent Application Publication
(10) Pub. No.: US 2010/0103763 A1
(43) Pub. Date: Apr. 29, 2010

(54) METHOD AND APPARATUS TO REPRODUCE PRODUCST MADE OF COMPOSITE MATERIAL HAVING SOLID PARTICLES EMBEDDED IN A POLYMERIC MATRIX AND METHOD AND DEVICE FOR DISPERSING SOLIDE PARTICLES INTO A VISCOUS LIQUID

(76) Inventor: Giuseppe Ponzielli, Cittiglio (IT)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/519,003

(22) PCT Filed: Dec. 13, 2007
(86) PCT No.: PCT/EP07/63919

§ 371 Date: Oct. 30, 2009

(30) Foreign Application Priority Data
Dec. 14, 2006 (IT) MI2006A002399

(51) Int. Cl. B01F 3/14; B29C 47/10

(52) U.S. Cl. 366/76.6

(57) ABSTRACT

A method to produce products made of composite material having solid particles embedded in a polymeric matrix provides for conveying a viscous liquid suitable to define the polymeric matrix along a first path; conveying agglomerates of elementary solid particles along a second path; combining the agglomerates with the viscous liquid; infiltrating the viscous liquid into the elementary solid particles along a third path by an infiltrating device; and dispersing the elementary solid particles into the viscous liquid along the third path by a dispersing device arranged downstream of the infiltrating device.

### FIELD OF INVENTION

The present invention relates to a method to produce products made of composite materials having solid particles embedded in a polymeric matrix.

### BACKGROUND

In general, products made of composite materials having a polymeric matrix embedding solid particles find growing numbers of applications, among the others, in structural reinforced parts, filled films, nanocomposites, etc. The increasing diffusion of products made of such composite materials relies on their high performances, versatility and relatively low manufacturing cost. Composite materials may provide mechanical and physical properties, which are able to satisfy several different specifications and depend on the shape, the amount and the constituent material of the solid particles.

The polymeric matrix is generally made of thermoplastic polymers, like, Polypropylene, Polyethylene, Polyammide, Polystirene, Acrilonitryle-Butadyene-Styrene, Polysulphone, Polyimmide, Polyvinyl Cloride, Polyethylene Terephtalate, etc. However, the polymeric matrix can be made of thermosetting resins. Examples of thermosetting resins are vulcanized rubber, phenol-formaldeide (bakelite), urea-formaldeide, melamine resins, polyester resins, epoxy resins, etc.

The solid particles embedded into the polymeric matrix are usually powders or fibers. Both powders and fibers are compounded in a liquid polymeric matrix by a liquid-solid mixing step, before solidification of the polymeric matrix.

The powders are fillers or additives, having spherical or prismatic shape, suitable to be compounded together with the polymeric matrix, and are, for example, mineral powders, wood flour, powdered organic substances, solid or hollow glass spheres, mostly having dimensions ranging from 1 nm to 10.000,00 nm (nm=nanometer).

The fibers embedded in the polymeric matrix have typically an elongated shape and are characterized by an aspect ratio, or the ratio of the length to the thickness. Fibers suitable to be embedded into the polymeric matrix are mineral fibers like glass fibers or synthetic fibers like carbon or aramid or polyester fibers, etc., or natural fibers like jute, cotton, hemp, flax, kenaf, sisal, coco, wool etc. The fibers are cut from strands of multiple endless filaments, like glass roving, and are often defined by a very low weight per unit length (TEX=weight in grams per kilometre). By example, the endless filament strands marketed by Vetrotex-Europe as roving RO99 P319 consist of E glass filaments of 17 micron diameter, each strand having a TEX value of 1200 and comprises about 2000 filaments.

In general, the solid particles, whether powders or fibers, grant a positive mechanical contribution to the final composite material provided that they are fully dispersed throughout the liquid polymeric matrix, before the polymeric matrix has finally solidified.

Full dispersion means that each elementary solid particle has been completely surrounded by the liquid polymeric matrix during the liquid-solid mixing step or, in other words, that the liquid-solid interfacial area equals to the sum of all outer surface areas of all elementary solid particles. If, for example, N is the number of all elementary solid particles of spherical shape and R the mean statistical radius of the elementary solid particles, full dispersion takes place when the liquid-solid interfacial surface Sᵢ equals to N4πR². On the other hand, if elementary particles have a cylindrical shape, as by example most of filaments, the full dispersion occurs when the liquid-solid interface Sᵢ equals to NL2Rπ, where L is the length of the cylindrical particle and R the radius of the mean statistical cross section.

In order to better understand the meaning of the full powder dispersion into a viscous liquid polymeric matrix it is worthy recalling the concepts of aggregate and agglomerate. The aggregate is the elementary individual powder particle as, for example, obtained by a pulverization process, and often defined in terms of mean, statistical size. By example, when a powder is referred as to have statistical mean size of 2μ, it means that the mean statistical size of the aggregates defining the powder is 2μ. In practice, aggregates group into agglomerates under cohesive attractive forces, like first Van der Waals-Hamaker forces. For sake of clarity, the interfacial surface Si as above defined should be intended as the outer surface of the aggregates.

Van-der Waals-Hamaker forces affect not only powders but also fibers and filaments, even though Van-der Waals-Hamaker forces are stronger with powders than with fibers and filaments. Moreover, the filaments of a strand are quite difficult to disperse as the upper critical energy dischargeable upon them, without breaking them, is rather low. Obviously it is important not to break the filaments in an uncontrolled way when dispersing the filaments into the liquid polymeric matrix in order not to impair the length of the fibers and, as a consequence, the mechanical properties of the composite material.

In conclusion, the meaning of the term “aggregate” encompasses an individual powder particle and an individual fiber, and the meaning of the term “agglomerate” encompasses a group of individual powder particles and an endless filament strand or bundle.

A thermoplastic resin or a thermosetting resin suitable to define the polymeric matrix is liquefied by plastification or melting into a liquid polymeric matrix having typical viscosity values ranging from 10 Pas to 20.000 Pas, whereas the agglomerates are introduced into the liquid polymeric matrix.

Known methods teach how to disperse the aggregates into a polymeric matrix by plasticizing the polymeric matrix; by combining the agglomerates with the polymeric matrix as long as the latter finds in a viscous liquid state; and by mixing the composition in given sections of an extruder. The known methods are inadequate to disperse optimally the aggregates into the polymeric matrix as they discharge excessive pressure on the aggregates grouped into agglomerates. When excessive hydrostatic compressive pressure is discharged on the agglomerates, their density increases and the inter-aggregates free spaces forming capillary flow channels through the agglomerates become smaller, leading to a troublesome or sometimes impossible infiltration of the liquid polymeric matrix into the channels. Moreover, when the agglomerates are filament strands, an excessive mixing pressure may result into a large and uncontrolled breakdown of the filaments.

In particular, Patent GB 1,151,964 to Werner & Pfleiderer teaches how to introduce endless filament strands (roving) into a screw extruder where the polymeric matrix is conveyed. The extruder is a co-rotating, self-wiping twin screw extruder. The main drawback of the above-method is that the filaments, before being wetted by the liquid polymeric matrix are stressed by the screws thus undergoing an uncontrolled breakdown.

The Patent U.S. Pat. No. 5,110,275 to Werner & Pfleiderer teaches to introduce endless filament strands into a screw extruder through a pre-impregnating device. The pre-impregnating device is a static flow device and incurs in all drawbacks known from other similar devices for pultrusion, like the difficulty to calibrate the pulling force. Furthermore, the slow pulling speed calls for a rather high number of filament strands spools.

U.S. Pat. No. 6,186,769 to a Woodshed Technologies, teaches how to impregnate and feed endless filament strands to a cutting station wherein are pinched by rolls and cut into fibers, and feeding the fibers into an injection-moulding apparatus. One of the most evident drawbacks is the high fibers speed through pinching rolls that do not allows sufficient impregnation and requires a frequent adjustment of the roll's nip.

### SUMMARY

The object of the present invention is to provide a method to produce products made of composite materials having solid particles embedded in a polymeric matrix, which overcomes the drawbacks of the prior art methods and, in particular, improves the dispersion of solid particles throughout the polymeric matrix.

In accordance with the present invention there is provided a method to produce products made of composite materials having solid particles embedded in a polymeric matrix, the method comprising the steps of, conveying a viscous liquid suitable to define the polymeric matrix along a first path; conveying agglomerates of aggregates defining the elementary solid particles along a second path; and combining the agglomerates with the viscous liquid; the method comprising the additional steps of infiltrating the viscous liquid among the aggregates along a third path in an infiltrating device; and dispersing the aggregates into the viscous liquid along the third path in a dispersing device arranged downstream of the infiltrating device.

Moreover, the present invention relates to an apparatus suitable to produce products made of composite materials having elementary solid particles embedded in a polymeric matrix.

According to the present invention is realized an apparatus to produce products made of composite materials having solid particles embedded in a polymeric matrix, said apparatus comprising a plasticizing device for melting a polymer into a viscous liquid, suitable to define the polymeric matrix and for conveying the viscous liquid along a first path; a feeding device for feeding agglomerates of elementary solid particles or aggregates along a second path; the apparatus comprising an infiltrating device for infiltrating the viscous liquid among said aggregates along a third path; and a dispersing device arranged along the third path downstream of the infiltrating device for dispersing the aggregates into the viscous liquid along the third path.

The present invention relates to a method for dispersing solid particles in a viscous liquid.

According to the present invention there is provided a method for dispersing solid particles into a viscous liquid by a dispersing device when the viscous liquid and the solid particles are conveyed along a path; the method comprising the step of conveying the viscous liquid and the solid particles in a given direction in the dispersing device; the method further comprising penetrating the viscous liquid by sharp-ended elements transversely to the conveying direction.

The present invention further relates to an apparatus for dispersing solid particles into a viscous liquid.

According to the present invention is realized a device for dispersing solid particles into a viscous liquid comprising an extruder, having a shaft rotatable about an axis; at least one screw module fixed to the shaft and suitable to convey the viscous liquid and the solid particles along a path in a delivery direction; the extruder comprises at least one dispersing module fixed to the shaft and comprising first sharp-ended elements, which are rotatable into the viscous liquid and are co-oriented with the rotational direction of the shaft.

### BRIEF DESCRIPTION OF THE DRAWINGS

Additional elements and advantages of the present invention will become more clear through the following illustrative, non limiting, embodying examples, referring to the figures of the attached drawings, where:

FIG. 1 is a perspective view, with some parts removed for clarity and other parts sectioned, of an apparatus according to the present invention;

FIG. 2 is a perspective view in an enlarged scale, with some parts removed for clarity and other parts sectioned, of a detail of the apparatus FIG. 1;

FIG. 3 is a perspective view in an enlarged scale, with some parts removed for clarity and other parts sectioned, of a further detail of the apparatus of FIG. 1 in operation;

FIG. 4 is a perspective view, with some parts removed for clarity and other parts sectioned, of a dispersing device according to the present invention;

FIG. 5 is a cross section view in enlarged scale of the dispersing device of FIG. 4;

FIG. 6 is a cross section view of a variation of the dispersing device of FIGS. 4 and 5;

FIG. 7 is a perspective view, with some parts removed for clarity and part in section, of an apparatus to produce composite materials having solid particles embedded into a polymeric matrix in accordance with a second embodiment of the present invention;

FIG. 8 is a perspective view in an enlarged scale, with some parts removed for clarity and other parts sectioned, of a detail of the apparatus of FIG. 7;

FIG. 9 is a perspective view in an enlarged scale, with some parts removed for clarity and other parts sectioned, of a further detail of the apparatus of FIG. 7;

FIG. 10 is a perspective view in an enlarged scale of a detail of the apparatus of FIG. 9;

FIG. 11 is a perspective view, with parts in section, of the detail of FIG. 10;

FIG. 12 is a perspective view in an enlarged scale of a detail of FIG. 9;

FIG. 13 is a perspective view, with some parts sectioned and other parts removed for clarity, of an apparatus to produce composite materials having solid particles embedded into a polymeric matrix in accordance with a third embodiment of the present invention;

FIG. 14 is a perspective view, with some parts sectioned and other parts removed for clarity, of an apparatus to produce composite materials having solid particles embedded into a polymeric matrix in accordance with a fourth embodiment of the present invention; and

FIG. 15 is a sectioned front view, in an enlarged scale, of a detail of the apparatus of FIG. 14.

### DETAILED DESCRIPTION OF THE PREFERRED EMBODIMENTS

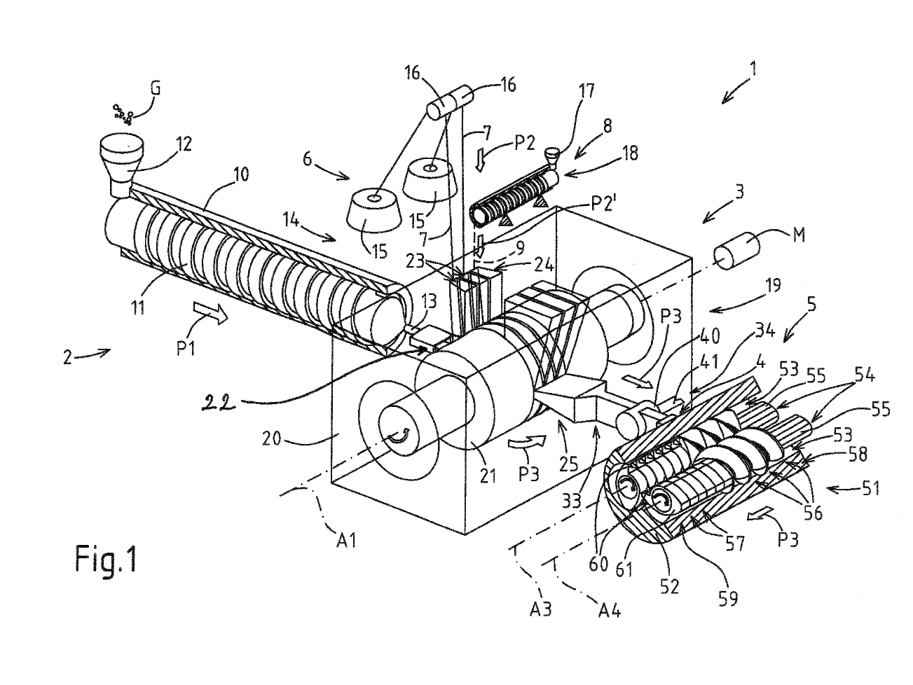

Referring to FIG. 1, reference numeral 1 indicates an apparatus to produce products made of composite materials having solid particles embedded into a polymeric matrix. Apparatus 1 includes a plasticizing device 2, an infiltrating device 3; a cutting device 4; and a dispersing device 5.

The plasticizing device 2 has the function of plasticizing a thermoplastic polymer and may be omitted since is not necessary when the polymeric matrix is made of a thermosetting resin. The apparatus 1 includes an endless filament strand feeding device 6 for conveying the endless filaments strands 7 to the infiltrating device 3, and a powder agglomerate feeding device 8 for conveying powder agglomerates 9 to the infiltrating device 3. The endless filament strand 7 is essentially an agglomerate of elementary solid particles such as elongated fibers or aggregates. In a similar way, the powder agglomerates 9 is a bonded group of elementary solid particles or the aggregates. The plasticizing device 2 includes a housing 10; a plasticizing screw 11 for rotation within the housing 10, and also for pumping the viscous liquid; a hopper 12 to feed a polymer, e.g. in granules G, to the housing 10 and to the plasticizing screw 11; and to an exit die 13. The granules G are fed to the hopper 12 and are conveyed by the plasticizing screw 11 to the exit die 13 along a path P1. The housing 10 is heated by known means not shown in the enclosed figures as to melt granules G, in cooperation with the plasticizing screw 11 set in rotation by a driving motor, while the exit die 13 feeds the polymeric material in the viscous liquid state to the infiltrating device 3. For sake of conciseness, the polymeric material in viscous liquid state will be referred, in the following, to as “viscous liquid”.

The filament strand-feeding device 6 includes an unwinding station 14 for spools 15 of filament strands 7; and guiding elements 16 to guide the filament strands 7 to the infiltrating device 3 along a path P2.

The powder agglomerate-feeding device 8 comprises a feeding hopper 17 connected to a powered screw gravimetric dosing unit 18 to feed powder agglomerates 9 to the infiltrating device 3 along a path P2′.

The infiltrating device 3 and the dispersing device 5 define the common path P3 where both viscous liquid and agglomerates are conveyed.

The infiltrating device 3 has the function of infiltrating the viscous liquid among the filaments of the filament strand 7 so that the viscous liquid surrounds completely or nearly completely each filament of the filament strand 7. In a similar manner, the infiltrating device 3 has the function of infiltrating the viscous liquid among the powder agglomerates 9 so that the viscous liquid surrounds completely or nearly completely each elementary solid particle of the powder agglomerates 9. Moreover, in the case of filament strands the infiltrating device 3 has the function to pull and unwind the filament strand 7 from the filament strand-feeding device 6.

In particular, the infiltrating device 3 comprises an annular channel pump 19 for dragging viscous liquids, which comprises a pump housing 20; and a rotor 21, which rotates about an axis Al relative to the pump housing 20 and is driven by a variable speed motor M.

The pump housing 20 has a port 22 for feeding the viscous liquid to the rotor 21; two ports 23 for feeding two filament strands 7 to the rotor 21; a port 24 for feeding powders 9 to the rotor 21. The infiltrating device 3 includes a discharge port connected to a discharge duct 25, through which the viscous liquid combined with the filament strands 7 and/or with the powder agglomerates 9, is forced by the pump 19 to the dispersing device 5.

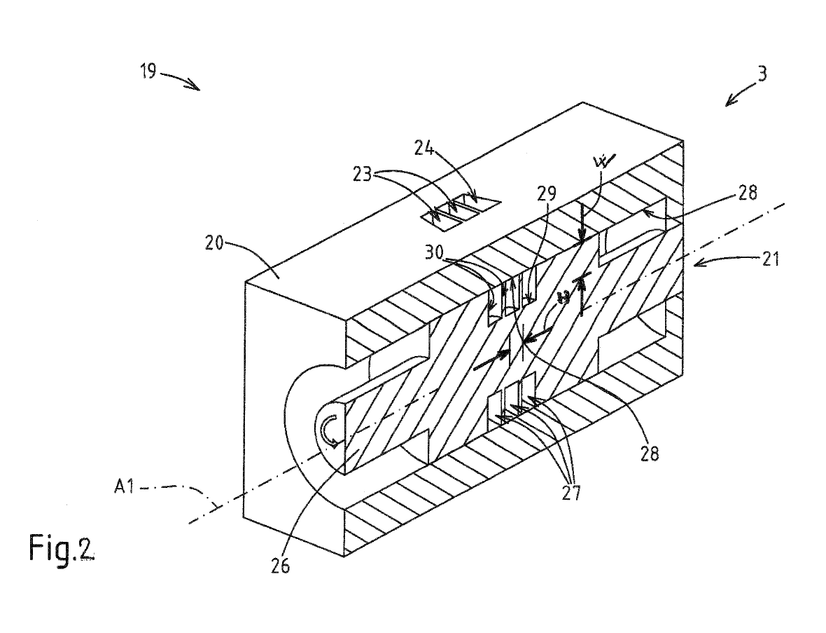

Referring to the FIG. 2, the rotor 21 has a shaft 26 rotating about axis A1; three annular channels 27, each defined by a cylindrical face 28 of the stator 20; a cylindrical face 29 of the rotor 21; and two annular faces 30 facing the rotor 21. Each annular channel 27 has a width W and a depth H.

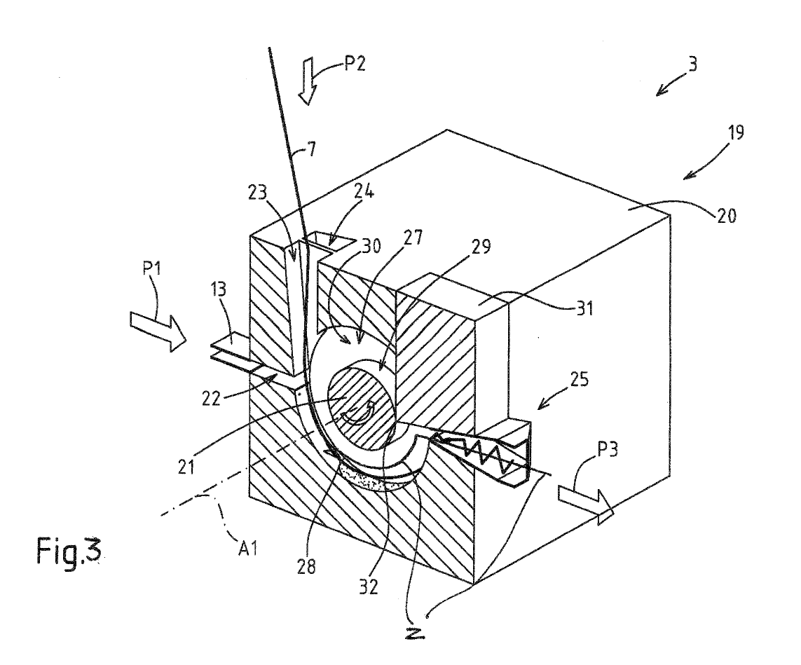

Referring to the FIG. 3, the pump 19 includes three diverting elements 31 (only one of them shown in FIG. 3). Each diverting element is essentially defined by a prismatic body, which is mounted in a recess of the pump housing 20, protrudes partially in the annular channel 27, and is provided with an edge 32 contacting the rotor 21 along the cylindrical face 29 in a way to scrape the cylindrical face 29 and divert the viscous liquid and the agglomerates toward the discharge duct 25. The diverting element 31 contributes to determine the positive pressure gradient in the viscous liquid fed along the annular channel 27.

From an operational viewpoint, the infiltrating device 3 receives in parallel the viscous liquid from the plasticizing device 2 and the filament strands 7 from the filament strand-feeding device 6. When the rotor 21 of the pump 19 is rotating and receives simultaneously the viscous liquid and the filament strands, the viscous liquid drags or “pulls” each filament strand 7 in the rotational direction indicated by the arrow in FIG. 1 toward the discharge duct 25. The “pulling” effect undergone by the filament strand 7 results from the combined action of the rotation of the rotor 21 which promotes the drag of the viscous liquid and in cascade the drag of the filament strand 7, due to the shear stresses arising between the viscous liquid and the filament strand 7. Thus the “pulling” force is determined by the product of the viscous shear stress τ with the outside filament strand 7 wetted surface area A (Pulling force ≅τ A). Referring again to FIG. 3, when the viscous liquid and the filament strand 7 get close to the discharge port, they are forced by the corresponding diverting element 31 to exit from the annular channel 27, deviating from an essentially circumferential direction to an essentially radial direction through the discharge duct 25.

Within the annular channel pump 19, along a first portion of the annular channel 27 the filaments strands 7 are substantially dragged by the viscous liquid (drag flow), whereas in a second portion of the annular channel pump 19, in proximity of the discharge duct 25, the filament strands 7 are substantially pressed or pushed by the viscous liquid (pressure flow).

The positive pressure capability of the pump 19 ranges typically between more than 0 bar and 100 bar, preferably between 5 and 50 bar, and is necessary in order to face the pressure drop that the filament strand-viscous liquid composition undergo downstream of the annular channel 27.

In other words, the pump 19 develops a positive pressure gradient +ΔP/dz (with the z coordinate placed on the channel circumference) in the last portion of the annular channel 29, with a maximum pressure near the inlet of the discharge duct 25, whereas the strand-viscous liquid composition undergo a negative pressure gradient −ΔP/dz (with the z coordinate placed on the discharge duct 25 delivery direction) having the maximum value near the discharge duct 25 inlet.

In general, the capability of an annular channel 27 to generate a positive pressurization of the viscous liquid is a function of the portion of annular channel 27 filled with viscous liquid. The portion of annular channel 27 filled with viscous liquid is expressed in angular units (radians). If, for example, a given pressure drop downstream of the annular channel 27 requires a filling length of n radians, (half of the annular channel circumference), it means that with a lower pressure drop, we need a filling length shorter than π radians and vice-versa a filling length longer than n radians for a higher pressure drop. The longer is the filled channel portion, the longer is the mean residence time for the filament strand 7 to be infiltrated.

The geometry of the discharge duct 25 plays a very important role to optimise the infiltration process of the infiltrating device 3. The discharge duct 25 has a cross section, which allows for the deformation of filament strand 7 transversely to the flow direction. The filaments deform in waves and folds promoting further infiltration between the filaments (FIG. 3). The filaments of the filament strand 7 deform along transversal directions due to the reduced delivery speed of the liquid when passing from the annular channel 27 to the discharge duct 25 as a consequence of an increase of the cross section of the discharge duct 25. Therefore, increasing or reducing the cross section of the discharge port 25 is a way to make the filaments of the filament strands 7 to get spaced or closed and thus to promote a very efficient infiltration, in addition to the infiltration occurring within the annular channel.

It may happen that the pressure drop provided by the discharge duct 25 is not enough to determine a filling portion of the annular channel 27 as long as to grant the desired residence time of the filament strand-viscous liquid composition within the annular channel 27. If the filament strands 7 do not reside enough time within the annular channel 27 it is likely that the infiltration step is not complete. A way to adjust the pressure drop in the annular channel 27, consists in arranging a flow regulator 34 along the discharge duct 25 (FIG. 1). The flow regulator 34 can be selected among various available conventional devices for adjusting the flow passage of a viscous liquid, like for example a sliding piston with one or more flow passages.

As shown in the FIG. 1, two filament strands 7 are fed in two feed port 23 and powders 9 are fed into one feed port 24. Powders 9 are mixed together with the viscous liquid within the annular channel 27 and conveyed up to the diverting element 31, from where are pushed in pressure through the discharge duct 25.

The cutting device 4 accomplishes the function of cutting the filaments into fibers of the desired length and is arranged along the discharge duct 25 and upstream of the inlet port of the dispersing device 5. The cutting device 4 can be selected among conventional cutting devices suitable to cut filaments embedded in a viscous liquid, like, for example, blade cutters, screw cutters, piston cutters etc.

Referring to FIG. 1, the dispersing device 5 includes a self-wiping, co-rotating twin screw extruder 51 having a housing 52 with two communicating, parallel and adjacent cylindrical chambers 53; and two rotors 54, for rotation within said chambers 53 about their respective axis A3 and A4, partially intersecting.

Each rotor 54 is driven by a motor not shown in the enclosed figures and comprises a splined shaft 55, on which are mounted modular screw elements 56, and dispersing elements 57. The modular screw elements 56 accomplish the function to convey and pump the viscous liquid along path P3 whereas the modular elements 57 have the function to disperse the aggregates, whether powder aggregates 9 or fibers into the viscous liquid.

In general, each rotor 54 includes a section 58 suitable to convey the viscous liquid-solid particles composition, and a section 59 suitable to disperse the aggregates into the viscous liquid. Each rotor 54 includes a series of sharp-ended elements 60, each being defined, according to FIG. 1, by a cone with its own axis tangentially oriented relative to the axis A3 or A4 of the respective rotor 54. In more details, each dispersing modular element 57 comprises a ring 61 with two symmetric lobes, and a sharp-ended element 60 fixed to the ring 61 near to one lobe.

The dispersing device 5 generates a pressure into the viscous liquid typically ranging between 5 and 1000 bar, preferably 5 and 500 bar.

According to an alternative embodiment not shown in the enclosed figures, the sharp-ended element 60 is a cylinder or a prism with a cone or a pyramid superposed. The sharp-ended elements have the apexes oriented tangentially to the shaft 55 so that sharp-ended element 60 “penetrates” into the viscous liquid and transfer shear forces in it for dispersing the aggregates, namely the fibers. Moreover sharp-ended elements 60 necessarily orientate the fibers in a cross direction relative to the screw axis. This orientation is particularly useful as it prevents fibers to be fully aligned, axially, in the product, thus promoting a higher isotropy degree in the reinforcing properties.

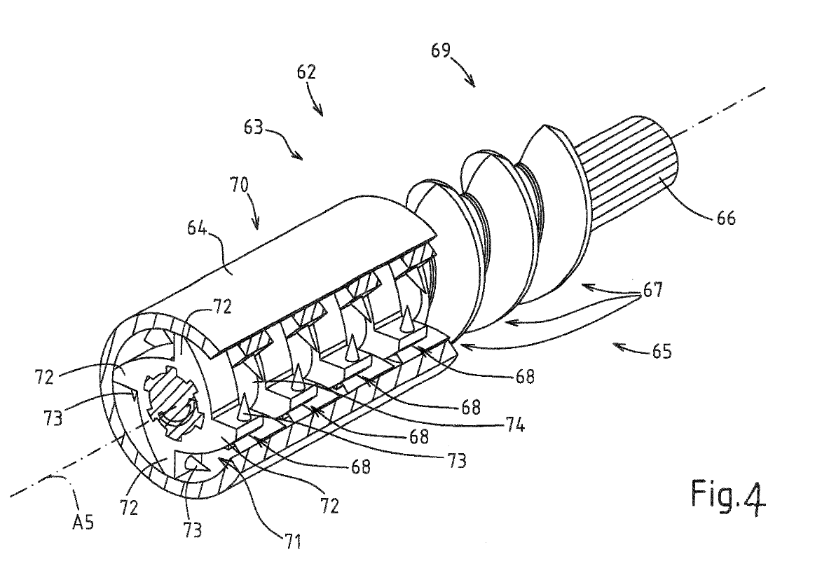

Referring to the alternative embodiment of FIGS. 4, 5 and 6, reference numeral 62 indicates a dispersing device comprising a screw extruder 63, which, in turn, comprises a housing 64; and a rotor 65 housed in housing 64 for rotation about an axis AS by a motor not shown.

The rotor 65 comprises a splined shaft 66, screw modules 67, and dispersing modules 68 both mounted on the splined shaft 66. The rotor 65 comprises a first section 69, which is defined by screw modules 67 suitable for conveying the aggregate-viscous liquid composition, and a second section 70, which is defined by dispersing modules 68 suitable to disperse the aggregates throughout the viscous liquid.

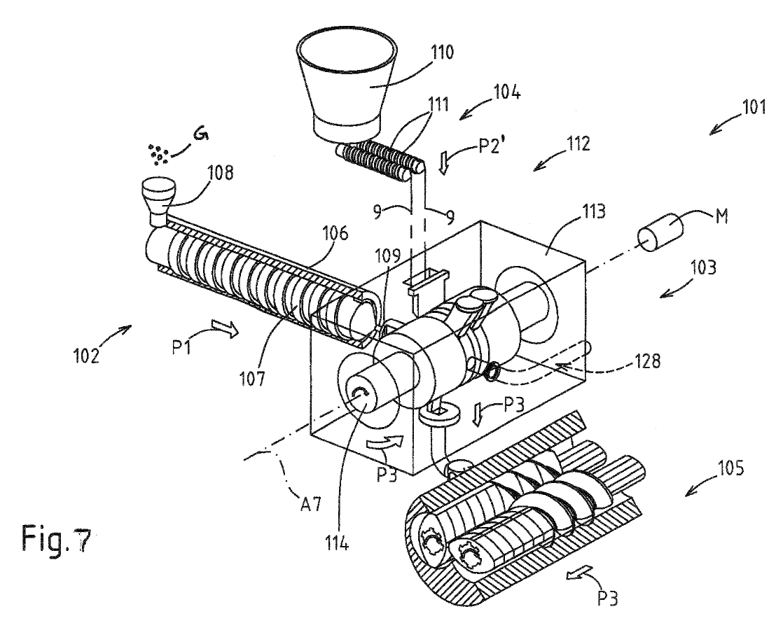

Each dispersing module 68 includes a ring 71; four arms 72 protruding essentially radially and evenly distributed about axis A5; four sharp-ended elements 73, each protruding from a respective arm 72 in a tangential direction; and a spacing element 74 (FIG. 7) for spacing ring 71 from an adjacent ring 71.

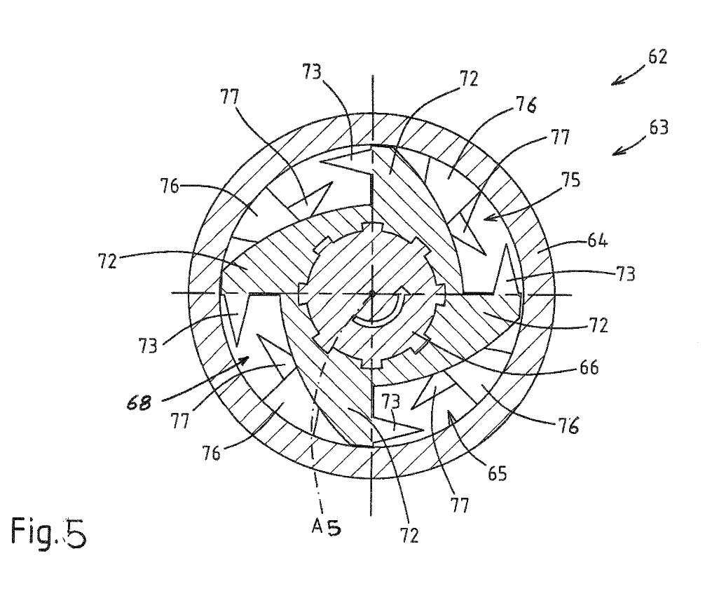

Screw extruder 63 comprises static dispersing modules 75 (FIG. 5), which are fixed on the housing 64 in an alternate axial sequence with the rings 71 of the moving dispersing modules 68. Each static dispersing module 75 extends towards a spacing element 74 and includes four radial arms 76 which protrude from housing 64 toward the axis A5 and four sharp-ended elements 77, having the same orientation, relative to the axis A6, as better shown in FIG. 5. Each sharp-ended element 77 is fixed in a tangential direction relative to axis A5 with the apex extending opposite to the direction of rotor 65.

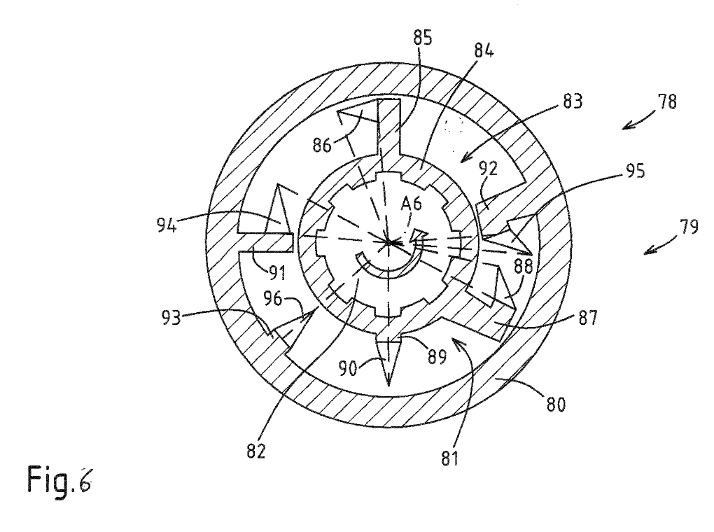

With reference to the variation of FIG. 6, reference numeral 78 indicates a dispersing device comprising a screw extruder 79, which comprises, in turn, a housing 80, and a rotor 81 driven by a motor not shown, which rotates about an axis A6, within the housing 80. The rotor 81 comprises a splined shaft 82, on which are mounted dispersing modules 83 and screw modules not shown in FIG. 6. Each dispersing module 83 comprises a ring 84; a radial arm 85 protruding from the ring 84 and supporting a sharp-ended element 86 oriented in a tangential direction; a radial arm 87 protruding from the ring 84 and supporting a sharp-ended element 88 oriented toward the ring 84; a radial arm 89 protruding from the ring 84 and supporting a sharp-ended element 90 oriented radially toward the housing 80. From housing 80 three arms 91, 92 and 93 protrude radially toward the rotor 81, which are assembled in an alternate series, along the axis A6, with the arms 85, 87 and 89 and support respective sharp-ended elements 94, 95 and 96. The sharp-ended element 94 is oriented in a tangential direction opposite to the rotation direction of rotor 81; sharp-ended element 95 is oriented in the opposite direction to the rotor 81 direction and toward housing 80; and the sharp-ended element 96 is oriented in a radial direction toward the rotor 81.

With reference to FIG. 7, reference numeral 101 indicates an apparatus to produce products made of composite materials having solid particles embedded in a polymeric matrix. The apparatus 101 includes a plasticizing device 102, an infiltrating device 103; a powder agglomerate feeding device 104 for powder agglomerates 9; and a dispersing device 105. The plasticizing device 102 comprises a housing 106; a plasticizing screw 107 for rotation within the housing 106; a hopper 108 to feed a polymer, e.g. in granules G, to the housing 106 and to the plasticizing screw 107 which accomplishes also the function to pump the viscous liquid; and the exit port 109. The granules G are fed to the hopper 108 and are conveyed by the plasticizing screw 107 down to the exit port 109 along a path P1. The housing 106 is heated by known means not shown in the enclosed figures so that granules G are progressively melted and the exit port 109 guides the polymer, in a viscous liquid state, to the infiltrating device 103.

The powder agglomerate feeding device 104 comprises a hopper 110 for feeding powder agglomerates 9, and a Loss-In-Weight twin screw gravimetric dosing unit to feed at uniform rate the powder agglomerates 9 to the infiltrating device 103 along a path P2′.

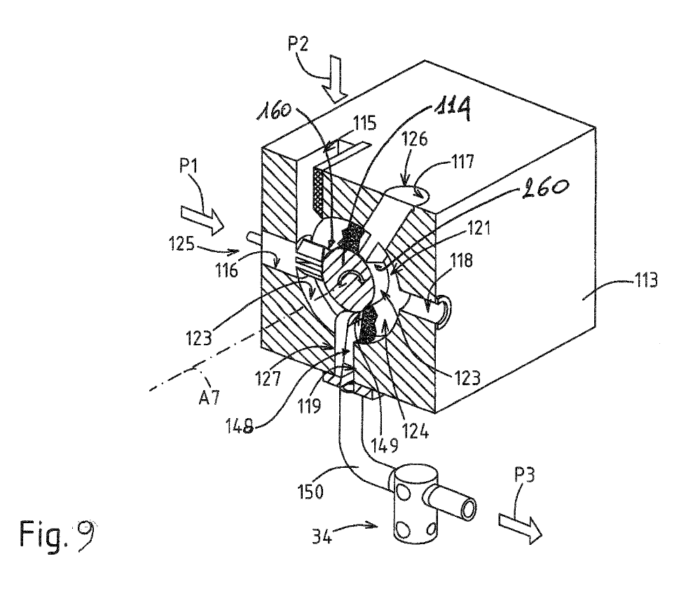

The infiltrating device 103 has the function of infiltrating the viscous liquid among the aggregates, which form the powder agglomerates 9, so that the complete or nearly complete surface of each spaced aggregate is wetted by the viscous liquid. In particular, the infiltrating device 103 comprises an annular channel pump 112, which includes a pump housing 113; and a rotor 114, which is suitable to be rotated about an axis A7 with respect to the pump housing 113 by a variable speed motor M. According to FIG. 9, the pump housing 113 comprises a powder agglomerate feed port 115; viscous liquid feed port 116; spreading port 117; degassing port 118; and discharge duct 119.

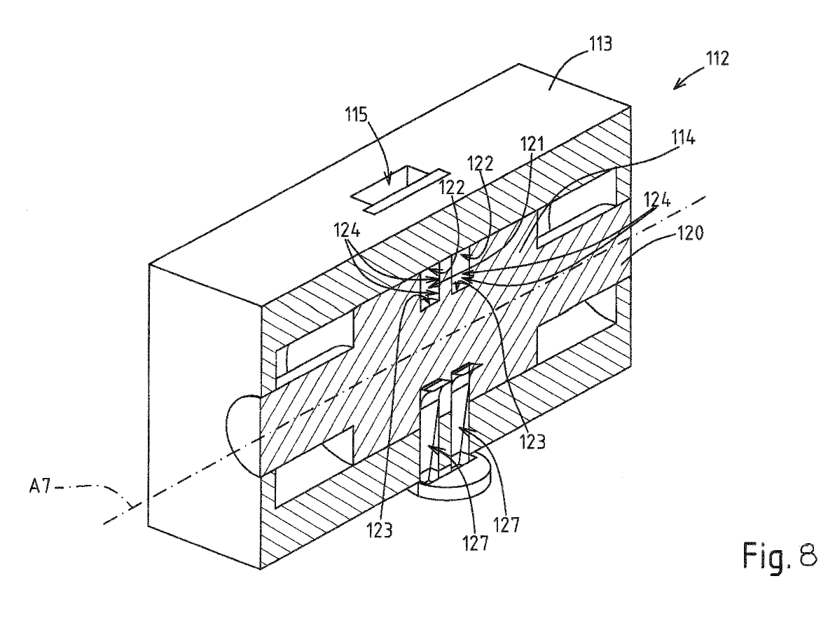

Referring to FIG. 8, the rotor 114 comprises a shaft 120 rotatable about axis A7; two annular channels 121, each being defined by an annular recess of the rotor 114 and by a cylindrical face 122 of the pump housing 113; a cylindrical face 123 of the rotor 114; and two annular faces 124 facing each other.

With reference to FIG. 9, ports 116, 115, 117, 118 and 119 are located near the annular channel 121, in sequence, with reference to the rotation direction of the rotor 114. The annular channel pump 113 comprises a spreading element 125, which is housed within the port 116 and protrudes inside the annular channel 121 toward the axis A7 of the rotor 114; another spreading element 126, which is housed within the port 117 and protrudes inside the annular channel 121 toward the axis A7; and a diverting element 127 which in part occupies the port 119 and protrudes into the annular channel 121. The port 118 is connected to a duct 128 (FIG. 7), which is fixed to a vacuum pump, not shown in the enclosed figures, for degassing the composition of viscous liquid and powder agglomerates 9.

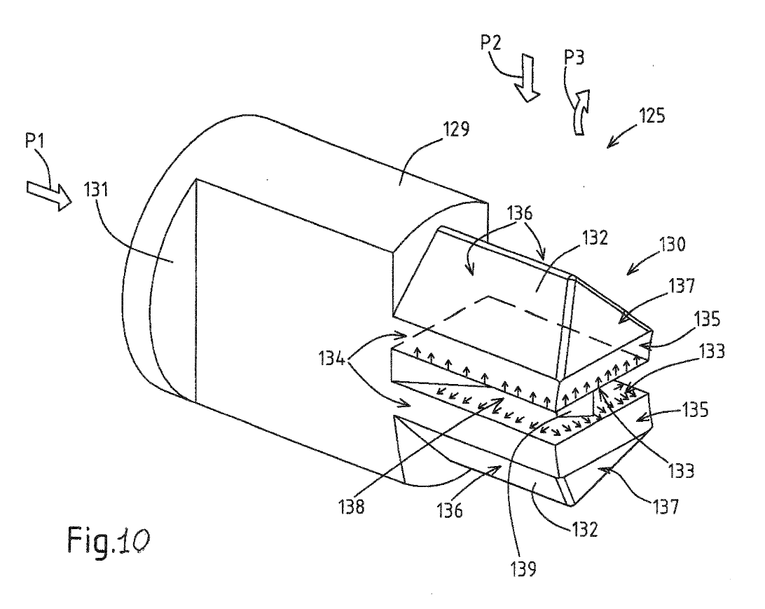

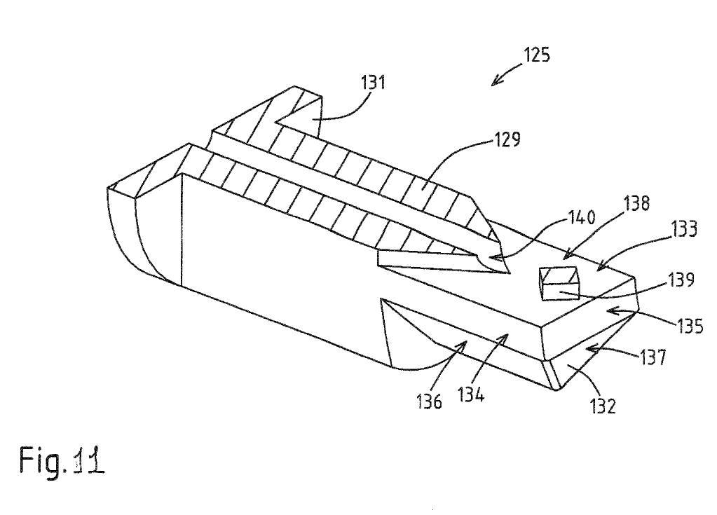

Referring to FIGS. 10 and 11, the spreading element 125 comprises a prismatic body 129 suitable to be housed into the port 116; a spreading die 130 suitable to match accurately the cross section of the annular channel 121 except for a small clearance 160 between the spreading die 130 and the annular faces 124 and the cylindrical face 123 of the annular channel 121, and a flange fixing the die head 130 to the pump housing 113, from outside. The die 130 consists of two mirror symmetric and facing prismoids 132. Each prismoid 132 is integral with the prismatic body 129 and comprises a main face 133 essentially radial and parallel and facing the opposite prismoid 132; two lateral faces 134, which are perpendicular and adjacent to the main face 133 and, in operation, parallel to the side faces 124 of the annular channel 121; a front face 135, which is adjacent and perpendicular to the main face 133 and, in operation, facing the cylindrical face 123 of the annular channel 121; two inclined faces 136, each being adjacent to a side face 134 and to the other inclined face 136; and an inclined face 137 adjacent to the inclined faces 136 and to the front face 135.

Between the main faces 133 there is provided a gap 138, which is partially occupied by a joining element 139 for joining the two prismoids 132 and avoiding bending or deformation of the same under the pressure of the viscous liquid flowing through the gap.

Referring to FIG. 11, the spreading element 125 is provided with a duct 140, which extends through the flange 131 and the prismatic body 129 and sets in communication the exit port 109 (FIG. 7) of the plasticizing device 102 to the gap 138 for supplying the viscous liquid to the annular channel 121. The viscous liquid, under pressure, flows through the gap 138 to the side faces 134 and to the front face 135 and gets spread over the annular faces 124 and the cylindrical face 123 of the annular channel 121.

The function of the spreading element 125 is to promote the largest interface between the viscous liquid and the powder aggregates prior to mixing.

Referring to the FIG. 9, downstream of the spreading element 125, the annular channel 121, in operation, gets covered by a thin viscous liquid film adhering to the annular faces 124 and to the cylindrical face 123. The feed port 115 is located vertically relative to the prismoid 132 and powder agglomerates fed through the feeding port 115 fall upon the prismoid 132 which diverts the falling powders agglomerates from the inclined faces 136 toward the annular faces 124, and from the inclined face 137 toward the cylindrical face 123. In such a way, the spreading element 125 permits also to realize a rather large viscous liquid-powder agglomerates interface.

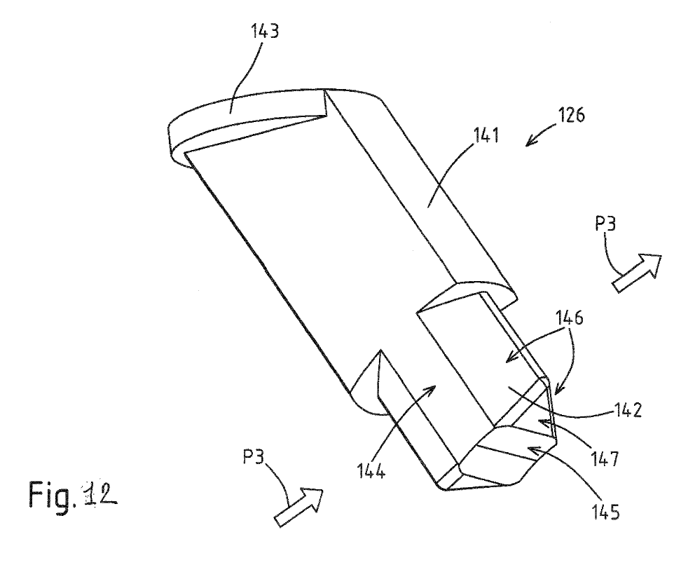

With reference to FIG. 12, the spreading element 126 comprises a prismatic body 141 suitable for flanging with the port 117; a spreading die 142 suitable to accurately match with the cross section of the annular channel 121 except for a small clearance 260 between the spreading die 142 and the annular faces 124 and the cylindrical face 123 of the annular channel 121, and a flange 143 fixed to the pump housing 113. The spreading die 142 is integral with the prismatic body 141 and comprises two side faces 144, which are, in operation, parallel to the side faces 124 of the annular channel 121; a front face 145, which, in operation, faces the cylindrical face 123 of the annular channel 121; two inclined faces 146, each being adjacent to a side face 144; an inclined face 147 adjacent to the inclined faces 146 and to the front face 145. The function of the spreading element 126 is to create a thin liquid film adhering to the annular faces 124 and to the cylindrical face 123 of the annular channel 121, to optimize degassing of the liquid-solid composition in a channel portion between the port 117 and the discharge duct 119.

Through the degassing port 118 gas is sucked from the channel 121 for degassing purposes. The spreading element 126 is not critical since degassing can be realized in alternative ways and, for example, in the dispersing device 105.

The spreading element 126 and the venting port 118 are functionally interconnected, and in a variation not shown are omitted.

The diverting element 127 includes a wedge having an edge 149 suitable to scrap the annular faces 124 and the cylindrical face 123. The diverting element 127 is arranged in a discharge duct 148.

The edge 149 can be positioned at a given distance from the cylindrical face 123 so as to allow for a portion of the viscous liquid to be recirculated in the form of a thin melt film against the annular channel 121. Useful spaced distance of the edge 149 from cylindrical face 123 is typically from about 0.01 mm to about 2 mm.

The viscous liquid combined with the infiltrated solid particles is diverted and guided through a connecting duct 150 suitable to feed the agglomerates-viscous liquid composition to the dispersing device 105, which has a similar function to the dispersing device 5 except for the sharp-ended elements 60, which are omitted. The connecting duct 150 connects the discharge duct 119 and the dispersing device 105, not shown in FIG. 9, and is a part of the infiltrating device 103.

Annular channel pump 112 is rotated in the opposite direction of the annular channel pump 19 and the powder agglomerates 9 are fed in the opposite direction with respect to the direction of the annular channel 121.

In some cases, the infiltration and dispersion process can be improved by pre-mixing the agglomerates with blowing agents, in order to promote agglomerates expansion when the agglomerate-viscous liquid composition is fed along the third path P3 i.e. through the infiltrating device 103 and through the dispersing device 105. A pre-mixing step of agglomerates with blowing agents is carried out before introducing the agglomerates into the infiltrating device 103 by any dry mixing device, like for example, a conventional turbomixer of the type, among the others, delivered by Plasmec Srl, Italy. A case of particular interest relates to nano-powders agglomerates here defined as those powders agglomerates made of aggregates with at least one dimension of the order of one nanometer (nm) or less. A typical, non limiting, example of this type of nanopowder agglomerates is montmorillonite nano-clays which comprise stacks of small platelets with dimensions of about 1 micron wide, 1 micron long and 1 nanometer thick and having free spaces between the platelets ranging between 1 to 3 nm. Since long time researchers are trying to achieve the exfoliation of nano-powder agglomerates, into polymer matrices, where exfoliation here refers to the result of surrounding all single platelets by the viscous liquids and distribute them chaotically throughout the viscous liquid. When achieved, e.g. by mixing in a screw processor, such exfoliation should bring, according to the theoretical models, to new composite materials showing outstanding properties, as a consequence of a large interfacial area between the aggregates and the viscous liquid and a high aspect ratio of the nano particles (>1000). Nevertheless the task is rather difficult because the inter particles distance is typically of the order of a few nm, (e.g. about 3 nm or less), which is competing with the polymer molecular chain size, especially for long range random coiled amorphous chains. Due to such molecular size problem the long range random coiled amorphous chains often succeed to enter among the platelets (intercalation) but at very low rates, as they move in a reptile fashion according to the reptation molecular flow model (Pls refer to the book “de Gennes, P. G., Scaling Concepts in Polymer Physics; Cornell University Press; Ithaca, N.Y., 1979). Therefore it is desirable to increase such interparticle passages to an extent where the polymeric liquids have chance to infiltrate easily. It has been found that intercalation of suitable blowing agent in such interparticles spaces, in the form of a polar liquid solution, prior to introducing such powder agglomerates into the infiltrating device, provides for an useful method to infiltrate and disperse, into a polymeric liquid, many powders, whether micrometric or nanometric, as often such powders are polar, hydrophilic substances and absorb easily such polar solutions. Intercalation of such blowing agents in the form of a solution is a critical condition since it is well known that solutions are characterized by particles, all having the size of atoms, small molecules or small ions, less than 1 nm in all dimensions and thus having the chance to enter easily even into the extremely small free spaces, between the aggregates of an agglomerate. Therefore it is disclosed here a multiple access, cascade mechanism, where, first small blowing agent particles are intercalated into the small inter-aggregates galleries of said nano or micro particles agglomerates by pre-mixing, prior to infiltrating; then such intercalated blowing agent particles, when subjected to proper temperature and pressure, within the infiltrating device, blow and space apart the contiguous aggregates, resulting into a magnification of the galleries dimensions of said nano or micro particles agglomerates, while, in parallel, liquid polymer molecules have chance to enter into such galleries, as long as they remain sufficiently spaced, under the expanded gas pressure, by conventional hydrodynamic flows, e.g. by pressure gradients or capillary flows. Preferably blowing takes place, after the liquid-particles composition leaves the infiltrating device, in the early section of the dispersing device, where suitable screw free volume should be arranged for blowing to occur.

Any variety of polar solvents systems can be used in preparing the solution of a suitable blowing agent, to be used for pre-mixing the micrometric or nanometric powders and by example water; alcohol; propylene glycol, 1,3 butylene glycol; and mixtures thereof and many others, being water the preferable solvent for obvious economical and environmental reasons.

A variety of blowing agents soluble into polar solvents can be usefully selected for the purpose, preferably among substances which decompose at temperature ranging about the processing temperatures of the polymers to be infiltrated among the aggregates of the micrometric or nanometric powder agglomerates, e.g. between 50° C. and 300° C. Blowing agents soluble in polar solvents are for example citric acid, sodium bicarbonate, ammonium carbonate etc. each being water soluble and showing solubility in water as about 133 g/100 ml, 30 g/100 ml and 17 g/100 ml at 20° C. and decomposition temperatures of about 175° C., 100-200° C. and 100° C., respectively. Generally useful concentrations of such blowing agents dissolved into said polar solvents range from about more than 0% to about 50% by weight, based on the total weight of the solution and preferably from about more than 0% and 10% by weight, based on the total weight of the solution.

An example of hydrophilic nanometric powder is sodium montmorillonite Na+, as marketed, for example, by Southern Clay Inc. US, under the name of Cloisite Na+.

It has been also found that water solutions of citric acid, at concentrations ranging from about 1% to about 50%, infiltrate successfully into the galleries of Cloisite Na+ platelets and are suitable to be introduced into hot polymeric liquids when processed into a similar apparatus to that disclosed by the present invention.

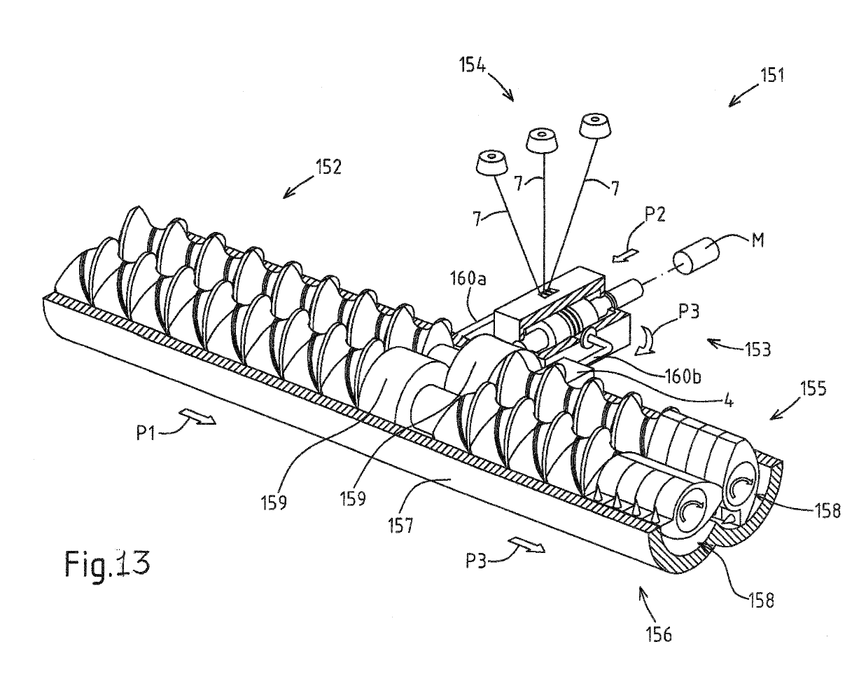

Referring to FIG. 13, the numeral 151 indicates an apparatus to make products in composite materials having solids particles embedded in a polymeric matrix. The apparatus 151 comprises a plasticizing device 152; an infiltrating device 153; a feeding device 154; and a dispersing device 155.

The peculiarity of the apparatus 151 is that the plasticizing device 152 and the dispersing device 155 represent two sections of the same screw extruder 156, which, in the figure is a self-wiping co-rotating twin screw extruder comprising a housing 157, and two rotors 158, each having a sealing block 159 which separates the housing 157 in two sections, a first section for plasticizing the polymer and for pumping it, in the liquid state, into the infiltrating device 153, and a second section for dispersing the aggregates into viscous liquid and for pumping said composition of aggregates and viscous liquid trough a die not shown for producing products made of composite material. The infiltrating device 153 is connected to the housing 157 of a feeding duct 160a upstream of the sealing blocks 159 and by a discharging duct 160b downstream of the sealing blocks 159 which is similar to the discharge duct 25 as described with reference to FIG. 1.

In the described example with reference to FIG. 13, reference is made to an apparatus 151 to disperse fibers in a viscous liquid, being understood that the same principle applies also to infiltration and dispersion of powder aggregates. Moreover, in alternative to the screw extruder 156 a single rotor screw extruder can be used. In accordance with a not shown variation of the apparatus of FIG. 13, more than one infiltrating device can be usefully mounted either in series or in parallel along the same screw extruder, for example, to accomplish selectively and separately the functions of infiltrating powder agglomerates 9 and filament agglomerates 7, namely filament strands.

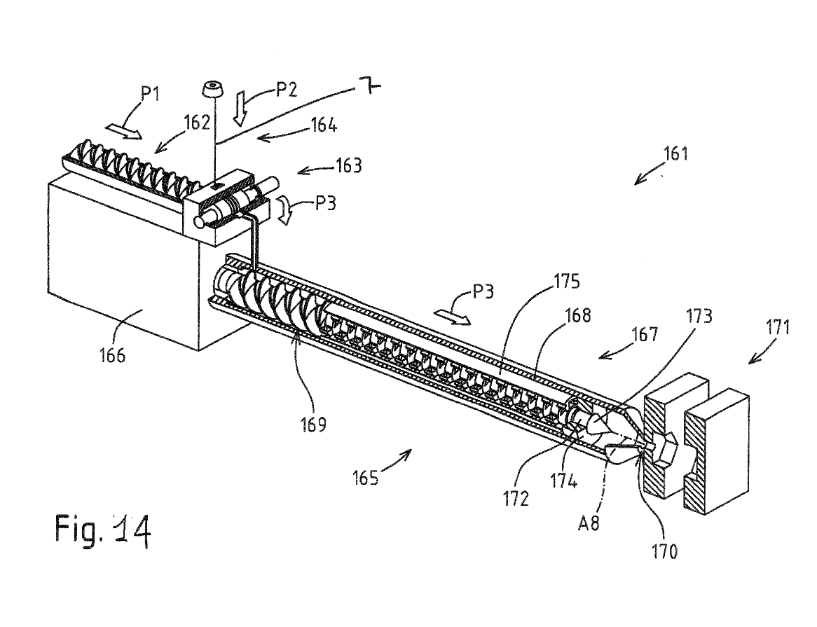

With reference to FIG. 14, reference numeral 161 identifies an apparatus to produce products having solid particles embedded in a polymeric matrix. The apparatus 161 includes a plasticizing and pumping device 162; an infiltrating device 163; a feeding device 164 for filament strands 7; and a dispersing device 165. The apparatus also includes driving devices not shown, for rotation of the plasticizing device 162, the infiltrating device 163 and the dispersing device 165. The plasticizing device 162 and the infiltrating device 163 are preferably positioned top-back the dispersing device 165.

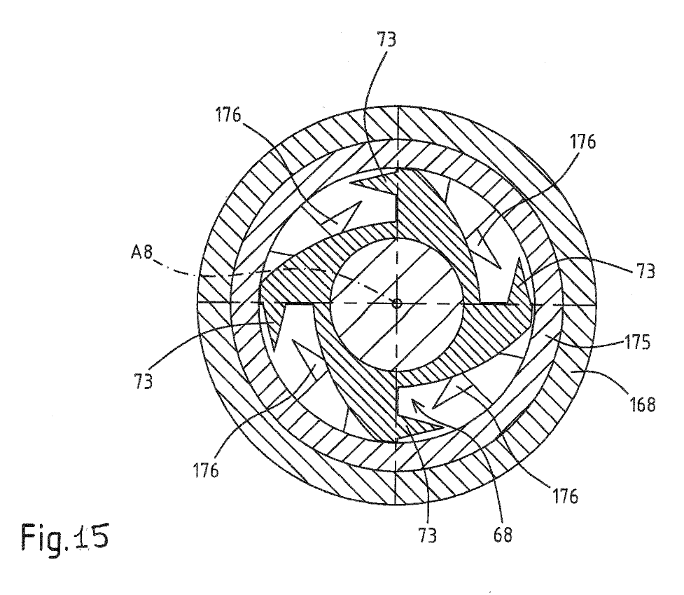

The dispersing device 165 comprises the screw extruder 167, which comprises in turn a housing 168; and a rotor 169, for rotation about an axis A8 and for reciprocating along the same axis A8, suitable to inject the viscous liquid through an end gate of the housing 168 where an injection nozzle 170 is fixed to inject the viscous liquid-solid composition into a mould 171. The rotor 169 is divided in two sections, one first section for conveying and pumping the liquid-fibers composition and a second section for dispersing the fibres and comprises a shaft 172 with an extreme free end 173 coupled with a non-return valve of one of the known types used in reciprocating injection moulding and with a bushing 175 which is designed to move jointly together with the shaft 172, along the axis A8, simultaneously with the shaft 169. The shaft 172 is arranged to move axially thanks to any suitable reciprocating system, either hydraulic or electric or different. In the second section for fibres dispersion, the rotor 169 includes dispersing modules 68 (described in details with reference to FIGS. 7 and 8) and the bushing 175 (FIG. 15), which has sharp-ended elements 176 that are fixed to the bushing 175 oriented in the opposite direction relative to the sharp-ended elements 73 of dispersing modules 68 according to the illustration in FIG. 15.

In general a method for dispersing solid particles into a viscous liquid by a dispersing device 5, 62, 78 when the viscous liquid and the solid particles are conveyed along path P3 includes the step of conveying the viscous liquid and the solid particles in a given direction in the dispersing device and penetrating the viscous liquid by sharp-ended elements transversely to the conveying direction.

The method further includes the step of rotating first sharp-ended elements 60, 73, 86, 88, 90 oriented tangentially with respect to a rotor 54, 65, 81 so as to penetrate the first sharp-ended elements 60, 73, 86, 88, 90 into the viscous liquid and between the solid particles for dispersing the solid particles into the viscous liquid.

The method further includes the step of rotating by a rotor the viscous liquid and the solid particles against second sharp-ended elements 77, 94, 95, 96 for dispersing the solid particles into the viscous liquid.

In general a device for dispersing solid particles into a viscous liquid comprises an extruder 51, 63, 79 having a shaft 55, 66, 82 rotatable about an axis A3, A4, A5, A6; at least one screw module 56, 67 fixed to the shaft 55, 66, 82 and suitable to convey the viscous liquid and the solid particles along path P3 in a delivery direction; at least one dispersing module 57, 68, 83 fixed to the shaft 55, 66, 82 and comprising first sharp-ended elements 60, 73, 86, 88, which are rotatable into the viscous liquid and are co-oriented with the rotational direction of the shaft 55, 66, 82.

The extruder 51, 63, 79 further comprises a housing; and second sharp-ended elements 77, 94, 95, 96 fixed to the housing and oriented in the opposite direction of the first sharp-ended elements 60, 73, 86, 88.

The products made by the apparatuses herein described can be either continuously extruded or intermittently moulded products made of composite material having fibers and/or powder aggregates embedded in the polymeric matrix.

1-46. (canceled)

47. Method to produce products made of composite materials having solid particles embedded in a polymeric matrix, the method comprising the steps of
conveying a viscous liquid suitable to define the polymeric matrix along a first path;
conveying agglomerates of aggregates defining the elementary solid particles along a second path;
combining the agglomerates with the viscous liquid in at least a rotating channel of an annular channel pump;
infiltrating the viscous liquid among the aggregates along a third path in the annular channel pump; and
dispersing the aggregates into the viscous liquid along the third path in a dispersing device arranged downstream of the annular channel pump; the third path extending, in part, along the annular channel rotating about a corresponding first axis.

48. Method according to claim 47, further comprising the step of infiltrating the viscous liquid between the aggregates under a first pressure to fill up inter-aggregates free spaces of each agglomerate at a first pressure; and dispersing the aggregates in the viscous liquid under a second pressure higher than the first pressure.

49. Method according to claim 48, wherein said first pressure ranges between more than 0 bar and 100 bar, preferably between 5 and 50 bar, and said second pressure ranges between 5 and 1000 bar, preferably between 5 and 500 bar.

50. Method according to claim 47, further comprising the step of adjusting a rotational speed of said annular channel about the first axis.

51. Method according to claim 47, wherein the infiltrating step provides for conveying the viscous liquid and the aggregates by the annular channel pump to a discharge duct and to a connecting duct.

52. Method according to claim 47, further comprising the step of degassing the viscous liquid combined with said solid particles inside the annular channel.

53. Method according to claim 47, wherein the aggregates are elongated fibers and the agglomerates are endless filament strands; said method providing for conveying an endless filament strand to the annular channel along the second path so as to let the viscous liquid dragging the filament strand and pulling the filament strand from a filament strand feeding device.

54. Method according to claim 53, further comprising the step of cutting the filament strand into fibers by a cutting device, which is arranged along the third path downstream of the annular channel pump; and upstream the dispersing device.

55. Method according to claim 54, further comprising the step of dispersing said fibers into the viscous liquid by said dispersing device when the viscous liquid and the fibers are conveyed along the third path by rotating first sharp-ended elements oriented tangentially with respect to a rotor against second sharp-ended elements so as to penetrate the first sharp-ended elements into the viscous liquid and between the fibers.

56. Method according to claim 47, wherein an aggregate is a powder elementary solid particle and an agglomerate is a group of bonded powder elementary solid particles; said method providing for feeding the agglomerates along the second path to the annular channel by at least one dosing unit; and spreading the viscous liquid over at least one face of the annular channel and distributing the agglomerates over the spread viscous liquid.

57. Method according to claim 56, including the step of spreading the viscous liquid by a first spreading element, which comprises a spreading head that occupies almost the total cross flow section of the annular channel, except for a small clearance between said spreading head and the face of the annular channel.

58. Method according to claim 56 including the step of pre-mixing the agglomerates with blowing agent solutions, which decompose at temperatures ranging between 50° C. and 300° C.; the blowing agents being dissolved in a solution comprising a polar solvent, in particular water, the blowing agents selected from the group consisting of citric acid, sodium bicarbonate and mixtures thereof; the concentration of said blowing agents into said solution ranging between more than 0% and 50% in weight; the mean particle dimension of said blowing agents dissolved into said solutions being less than 1 nanometer.

59. Apparatus to produce products made of composite materials having solid particles embedded in a polymeric matrix, said apparatus comprising a plasticizing device for melting a polymer into a viscous liquid suitable to define the polymeric matrix and for conveying the viscous liquid along a first path; a feeding device for feeding agglomerates of elementary solid particles or aggregates along a second path; the apparatus comprising an infiltrating device for infiltrating the viscous liquid among said aggregates along a third path; and a dispersing device arranged along the third path downstream of the infiltrating device for dispersing the aggregates into the viscous liquid along the third path; said infiltrating device comprising at least an annular channel pump comprising at least an annular channel for rotation about a corresponding first axis and suitable to drag said viscous liquids.

60. Apparatus according to claim 59, wherein the annular channel pump comprises a variable speed motor to adjust the rotational speed of the annular channel.

61. Apparatus according to claim 59, wherein said infiltrating device comprises a discharge duct of said at least one annular channel pump; the apparatus comprising a flow regulator, downstream of said annular channel pump.

62. Apparatus according to claim 59, wherein the annular channel pump comprises a pump housing; a rotor having at least one annular channel; and a port across the pump housing to connect said at least one annular channel to the outside for degassing said liquid-solid composition inside the annular channel or feed gaseous matter to the liquid-solid composition.

63. Apparatus according to claim 59, wherein said plasticizing device and said dispersing device are defined by a single extruder; said infiltrating device being bypass connected to said single extruder.

64. Apparatus according to claim 59, wherein said dispersing device comprises an extruder, having a housing; a rotor for rotation in said housing around a second axis and able to reciprocate along said second axis to inject said composition of said viscous liquid and said dispersed elementary solid particles through an injection nozzle; and a bushing suitable to support sharp-ended elements and to reciprocate jointly with the shaft.

65. Apparatus according to claim 59, wherein an aggregate is an elongated fiber and an agglomerate is an endless filament strand; said apparatus comprising an endless filament strand feeding device to said annular channel; the viscous liquid filling the annular channel for dragging the endless filament strand when the annular channel is set in rotation.

66. Apparatus according to claim 65 further comprising a cutting device located downstream of the infiltrating device and upstream of the dispersing device to cut an endless filament strand into fibers along the third path.

67. Apparatus according to claim 59, wherein the dispersing device comprises an extruder having a shaft rotatable about a fourth axis in a given direction; at least one screw conveying module fixed to the shaft and suitable to convey the viscous liquid and the fibres along the third path; and at least one dispersing module fixed to the shaft suitable to disperse said fibers in the viscous liquid.

68. Apparatus according to claim 67, wherein each dispersing module comprises first sharp-ended elements, which are rotatable into the viscous liquid and the fibers and are co-oriented with the rotational direction of the shaft, and second sharp-ended elements oriented in the opposite direction with respect to the rotational direction of said shaft.

69. Apparatus according to claim 59, wherein an aggregate is a powder elementary solid particle and an agglomerate is a bonded group of powder elementary solid particles; the apparatus comprising a powder agglomerates feeding device comprising a dosing unit for conveying continuously along the second path the powder agglomerates to the annular channel.

70. Apparatus according to claim 69, wherein the annular channel is defined by two annular faces and by a cylindrical face; the annular channel pump comprising a first spreading element suitable to spread said viscous liquid over at least one of the annular faces and over the cylindrical face; dosing unit distributing the powder agglomerates over the viscous liquid spread along the annular channel.

71. Apparatus according to claim 70, wherein said first spreading element comprises a spreading head which occupies almost the total cross flow section of the annular channel, except for a small clearance between said spreading head and the annular faces and the cylindrical face and comprises inclined faces suitable to distribute said powder agglomerates over the spread viscous liquid.

72. Apparatus according to claim 70, wherein the annular channel pump comprises a second spreading element to spread said composition of said powder agglomerates mixed into said viscous liquid, for degassing purposes; said second spreading element being located downstream of said first spreading element, in the rotational direction of said annular channel and comprising a spreading head which occupies almost the total cross flow section of said annular channel, except for a small clearance between said spreading head and the annular faces and the cylindrical face.
